(19) United States
(12) Patent Application Publication
(10) Pub. No.: US 2005/0207180 A1
(43) Pub. Date: Sep. 22, 2005

(54) Llc half-bridge converter

(76) Inventor: Frans Pansier, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/511,802

(22) PCT Filed: Apr. 1, 2003
(86) PCT No.: PCT/IB03/01318

§ 371 Date: Oct. 19, 2004

(30) Foreign Application Priority Data
Apr. 23, 2002 (EP) 02076620.0

(51) Int. Cl. H02M 3/335

(52) U.S. Cl. 363/16

(57) ABSTRACT

A resonant LLC-power converter comprises at least two transformers (T1, T2) of which the primary windings (LM1, LM2) are connected in series. Each one of the transformers (T1, T2) has a secondary winding (W1, W2; W11, W12, W21, W22) which supplies a non-zero current to the same load (LO) during the same period of time (TC).

The invention relates to a resonant LLC power converter (further referred to as LLC converter), and to an electronic apparatus comprising such a LLC converter.

U.S. Pat. No. 6,344,979 discloses a LLC converter which is called a LLC series resonant DC to DC converter. This LLC converter comprises a square-waveform generator, an LLC resonant network, a high frequency transformer, a rectifier circuit and an output filter.

The square-waveform generator is a half bridge inverter which contains two switches. Instead of a half bridge inverter, a full bridge inverter may be used. The LLC resonant network is coupled across one of the switches. The switches alternatively turn on and off. The LLC resonant circuit comprises a series arrangement of a series capacitor, a series inductor and a parallel inductor. The parallel inductor is arranged in parallel with a primary winding of a transformer. The series inductor can be implemented as an external component or as a leakage inductance of the transformer. The parallel inductor can be implemented as an external component or as the magnetizing inductance of the transformer. The rectifier circuit is connected to a secondary winding of the transformer to supply a DC output voltage to the load. The rectifier circuit may comprise a center-tapped or a full-bridge rectifier. The output filter comprises a capacitor to filter out the high frequency ripple.

The gate signals applied to the MOSFET switches are complementary and its duty cycles are 50%. A variable operating frequency control is used to regulate the output voltage. The operation principle of the LLC converter is described for three cases.

In the usual high volume electronics applications, the transformer in a LLC converter needs to be tailored to enable to reach the required specification at minimal costs.

However, if the LLC converter will be sold in relatively low quantities, it is not economical feasible to design and produce a new transformer.

It is an object of the invention to provide a LLC converter with an existing transformer which has a specification which is too low to be used in the LLC converter.

To this end, a first aspect of the invention provides a LLC converter comprising at least two transformers, primary windings of the at least two transformers are coupled in series, each one of the at least two transformers has a secondary winding for supplying a non-zero current to a same load during a substantially same period of time. A second aspect of the invention provides an electronic apparatus comprising such a LLC converter as claimed in claim 6.

The LLC converter is a current driven power supply topology. The current in the primary windings of the transformers is equal because they are arranged in series. For each transformer holds that the primary current is the sum of the current of the secondary winding and the magnetizing current of the transformer. When both transformers deliver current to the load, the voltage across the transformers is substantially equal. Consequently, the volt-seconds products are substantially equal and thus the magnetizing currents are substantially equal. In this way a DC offset is prevented without any additional measures. The voltage control of the outputs is maintained, and the balancing between the transformers is guaranteed.

Thus, to supply a power which is larger than can be supplied by one of the transformers, it is possible to use existing transformers of which the primary windings are arranged in series and of which at least one of the secondary windings of each of the transformers supply current to a same load during a same period of time. It is not required to design and manufacture a new single transformer able to supply the large power. The size of each of the transformers may be considerable smaller than the size of the single transformer. This might be especially important when the height of the transformers should be as small as possible to obtain a shallow design as preferred in, for example a display apparatus with a shallow depth. Further, the use of more than one transformer is an easy way to increase the possible number of output pins without the need for an extraordinary large transformer.

The basic idea in accordance with the invention is not limited to a LLC converter with two transformers, it is possible to arrange the primary windings of more than two transformers in series, provided the condition is still met that all transformers deliver current to the same load during substantially the same period of time such that the voltages over all the transformers are substantially equal.

It is possible that at least one of the transformers comprises at least one further secondary winding (further referred to as auxiliary winding) to supply power to other loads (circuits). As stated before, it is important that the secondary windings which supply power to the same load all supply current during the common period in time. This imposes restrictions on the power supplied by the auxiliary windings. The total power supplied by every transformer should be larger than the power supplied to the auxiliary windings.

The system appeared to be quite insensitive to tolerances, a mismatch of more than 10% of the transformer specifications does not prevent the correct operation.

In the embodiment of claim 3 the LLC converter comprises the first transformer which has a first predetermined number of further secondary windings to supply a first total power to associated loads, and the second transformer which has a second predetermined number of further secondary windings to supply a second total power to associated loads. The first total power minus the second total power must be less than the power supplied by the first secondary winding. And, the second total power minus the first total power must be less than the power supplied by the second secondary winding. A similar constraint is valid for a series arrangement of more than two transformers. In this manner, both transformers will supply current to the load.

In the embodiment of claim 2, a similar constraint is formulated if only one of the two transformers has auxiliary windings.

Further advantageous embodiments of the invention are defined in the dependent claims.

Advantages of the embodiments are that more pins are free to supply other voltages, less diodes are required, and less space is required.

These and other aspects of the invention are apparent from and will be elucidated with reference to the embodiments described hereinafter.

### BRIEF DESCRIPTION OF THE DRAWINGS

In the drawings:

FIG. 1 shows an equivalent circuit of a prior art LLC converter,

FIG. 2 shows waveforms elucidating the operation of the prior art LLC converter,

FIG. 3 shows a circuit diagram of a LLC converter in accordance with an embodiment of the invention,

FIG. 4 shows a circuit diagram of a LLC converter in accordance with an embodiment of the invention,

FIG. 5 shows a circuit diagram of an embodiment in accordance with the invention,

FIG. 6 shows a circuit diagram of an embodiment in accordance with the invention,

FIG. 7 shows a circuit diagram of an embodiment in accordance with the invention,

FIGS. 8 show waveform for elucidating the embodiments shown in FIGS. 5 and 6,

FIG. 9 shows a circuit diagram of an embodiment in accordance with the invention, and

FIGS. 10 show waveform for elucidating the embodiments shown in FIG. 9.

The same references in different Figures denote the same elements having the same function. In all Figures all windings of transformers are poled in the same manner. The dots indicating the polarity of the windings are not shown, but could either all be positioned near the tops of all the windings or all near the bottoms of all windings.

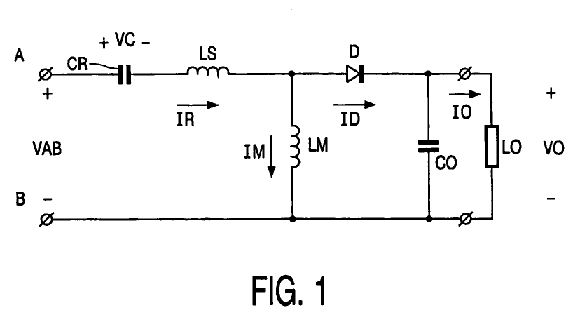

FIG. 1 shows an equivalent circuit of a prior art LLC converter which comprises a series arrangement of a resonance capacitor CR, a series inductor LS and a parallel inductor LM. The series arrangement is arranged between the nodes A and B to receive a square wave input voltage VAB. A series arrangement of a rectifier circuit D (which is shown as a single diode) and a smoothing capacitor CO is coupled in parallel with the parallel inductor LM. The output load LO is arranged in parallel with the smoothing capacitor CO. The current through the resonance capacitor CR and the series inductor LS is denoted by IR. The voltage across the resonance capacitor CR is denoted by VC. The current through the parallel inductance LM is denoted by IM. The current through the rectifier circuit D is denoted by ID. A current IO is supplied to the load LO, and an output voltage VO is present across the load LO.

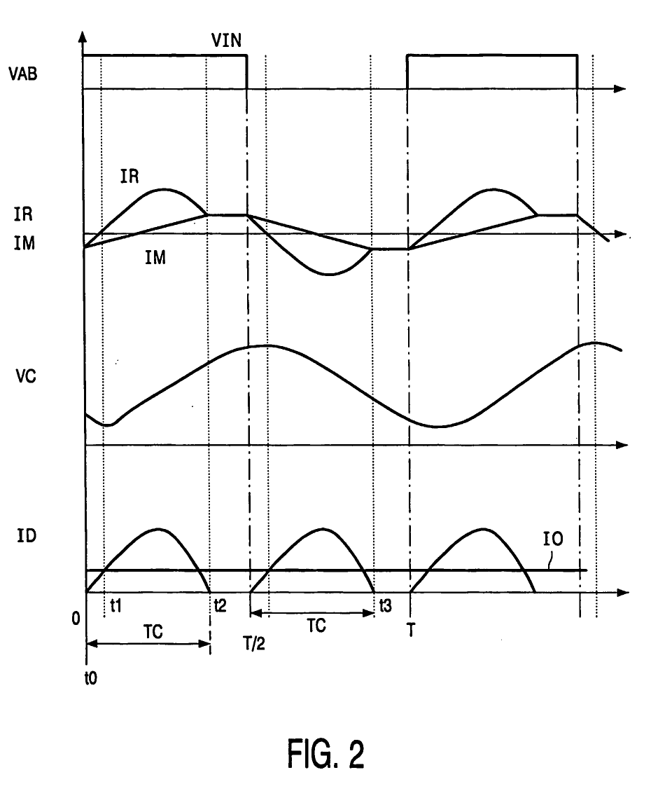

The operation of this equivalent circuit of a LLC converter is elucidated with respect to FIG. 2.

FIG. 2 shows waveforms elucidating the operation of the prior art LLC converter. From top to bottom, the waveforms represent: the input voltage VAB, the currents IR and IM, the voltage VC, and the currents ID and IO.

These waveforms are valid if the operating frequency of the LLC converter is between the first and the second resonance frequencies. The first resonance frequency is determined by the resonance capacitor CR, the series inductor LS, and the parallel inductor LM. The second resonance frequency is determined by the resonance capacitor CR and the series conductor LS, and is higher than the first resonance frequency.

When at the instant t0, the input voltage VAB changes from zero to the value VIN, a series resonance occurs determined by the resonance capacitor CR and the series inductor LS, and a sine-wave current is fed through the rectifier circuit D.

At the instant t2, at a half-period of the series resonance, the current ID through the diode D becomes zero. Now, the resonance capacitor CR resonates with the series arrangement of the series inductor LS and the parallel inductor LM. Because the inductance of LM is much larger than the inductance of LS, the resonance current IR which is equal to IM now, is almost constant between the instants t2 and T/2.

When at the instant T/2, the voltage VAB drops to zero, the resonance between the capacitor CR, and the inductors LS and LM is activated by the energy stored in the capacitor CR. The diode D starts conducting and the resonance is determined by the capacitor CR and the inductor LS again. At the instant t3, after half a period of the series resonance, the diode D stops conducting.

The conducting period of the diode D is denoted by TC. In a practical embodiment, the a full bridge rectifier may be used instead of the single diode D. Different diodes of the full bridge rectifier conduct during the positive and negative parts of the current IM.

At the instant T a next cycle starts, analogous to the cycle which starts at the instant t0, again, the input voltage VAB changes from zero to the value VIN, and so on.

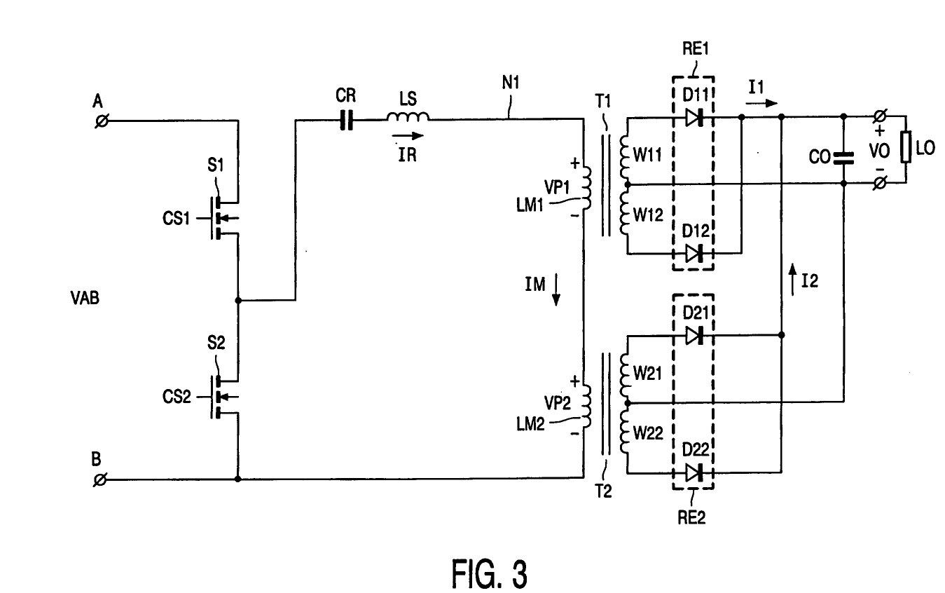

FIG. 3 shows a circuit diagram of a LLC converter in accordance with an embodiment of the invention.

The LLC converter comprises a series arrangement of an electronic switch S1 and an electronic switch S2. The series arrangement receives an input voltage VAB between the nodes A and B. In FIG. 3, by way of example, the switches S1, S2 are MOSFETs with internal body diodes. It is possible to use external diodes. If switches Si, S2 are used without intrinsic internal diodes, external diodes should be added in parallel with each one of the switches S1, S2. As disclosed in U.S. Pat. No. 6,344,979 it is possible to use a full bridge of switches, or two halve bridges in series.

The LLC converter further comprises a series arrangement of a primary winding LM1 of a transformer T1 and a primary winding LM2 of a transformer T2. The series arrangement is coupled between nodes N1 and B.

A series arrangement of the resonance capacitor CR and the series inductor LS is coupled between the node N1 and a junction of the switches S1 and S2.

The first transformer T1 has a secondary winding W11 which supplies current to the load LO via a diode D11, and a secondary winding W12 which supplies current to the load LO via a diode D12. The rectifier circuit RE1 comprises the diodes D11 and D12. The total current supplied by the transformer T1 is denoted by I1.

The second transformer T2 has a secondary winding W21 which supplies current to the load LO via a diode D21, and a secondary winding W22 which supplies current to the load LO via a diode D22. The rectifier circuit RE2 comprises the diodes D21 and D22. The total current supplied by the transformer T2 is denoted by I2.

A smoothing capacitor CO is coupled in parallel with the load LO. The voltage across the load LO is denoted by VO. The current through the series inductance LS is denoted by IR, and the current through both the transformer primaries LM1 and LM2 is IM.

In this embodiment in accordance with the invention, the primaries LM1 and LM2 of the transformers T1 and T2 are connected in series. The load LO receives power from both secondary windings W11, W12 and W21, W22 of the transformers T1 and T2 during the same period of time TC during which the diodes D11, D21 and D12, D22 are conductive.

The current IM in the primary windings LM1 and LM2 is equal because they are arranged in series. The current IM through the primary winding LM1 is the sum of the current in the secondary winding W11, W12 and the magnetizing current in the transformer T1. The current IM through the primary winding LM2 is the sum of the current in the secondary winding W21, W22 and the magnetizing current in the transformer T2.

When both transformers T1, T2 deliver current I1, I2 to the load LO, the voltage VP1, VP2 across the transformers T1, T2 is substantially equal. Consequently, the volt-seconds products are substantially equal and thus the magnetizing currents are substantially equal. In this way a DC offset is prevented without any additional measures. The control of the output voltage VO is maintained, and the balancing between the transformers T1, T2 is guaranteed.

The number of turns of winding W11 is equal to the number of turns of winding W21.

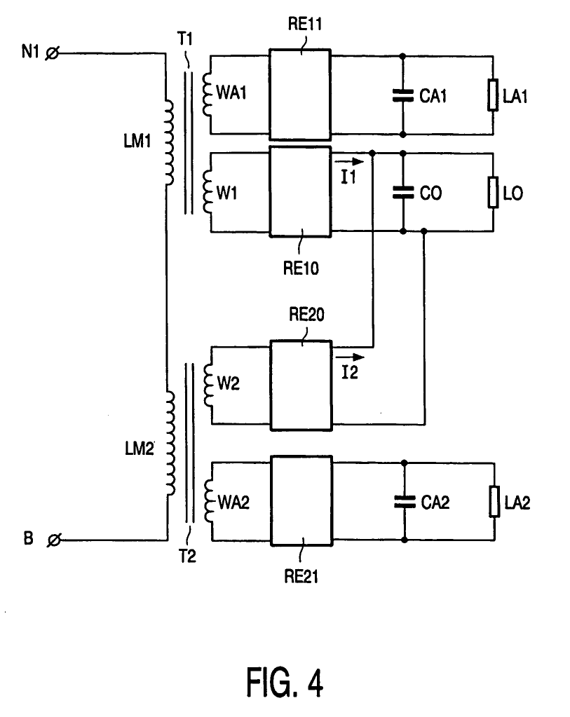

FIG. 4 shows a circuit diagram of a LLC converter in accordance with an embodiment of the invention.

A transformer T1 comprises a primary winding LM1 and secondary windings W1 and WA1. A transformer T2 comprises a primary winding LM2 and secondary windings W2 and WA2.

The primary windings LM1 and LM2 are arranged in series between the nodes N1 and B as defined in FIG. 3. The secondary winding W1 supplies the current I1 to the load LO via a rectifier circuit RE10. The secondary winding W2 supplies the current I2 to the load LO via a rectifier circuit RE20. A smoothing capacitor CO is arranged in parallel with the load LO.

The secondary or auxiliary winding WA1 supplies current to a load LA1 via a rectifier circuit RE11. A smoothing capacitor CA1 is arranged in parallel with the load LA1. The secondary or auxiliary winding WA2 supplies current to a load LA2 via a rectifier circuit RE21. A smoothing capacitor CA2 is arranged in parallel with the load LA1.

Preferably, the rectifier circuits RE10, RE20, RE11 and RE21 are full bridges.

The auxiliary winding WA1 supplies a first power to the load LA1, and the auxiliary winding WA2 supplies a second power to the load LA2. Because it is an important issue for the correct operation of the LLC converter that the voltage over the transformers T1 and T2 is substantially equal during the periods in time TC that power is supplied to the load LO, the transformer T1 and the transformer T2 should supply current I1 and I2, respectively, to the load LO. This is guaranteed if the first power minus the second power is less than the power supplied by the first secondary winding W1, and if the second power minus the first power is less than the power supplied by the second secondary winding W2. In this manner, both transformers T1 and T2 will supply current I1, I2 to the load LO.

A similar constraint is valid for a series arrangement of more than two transformers.

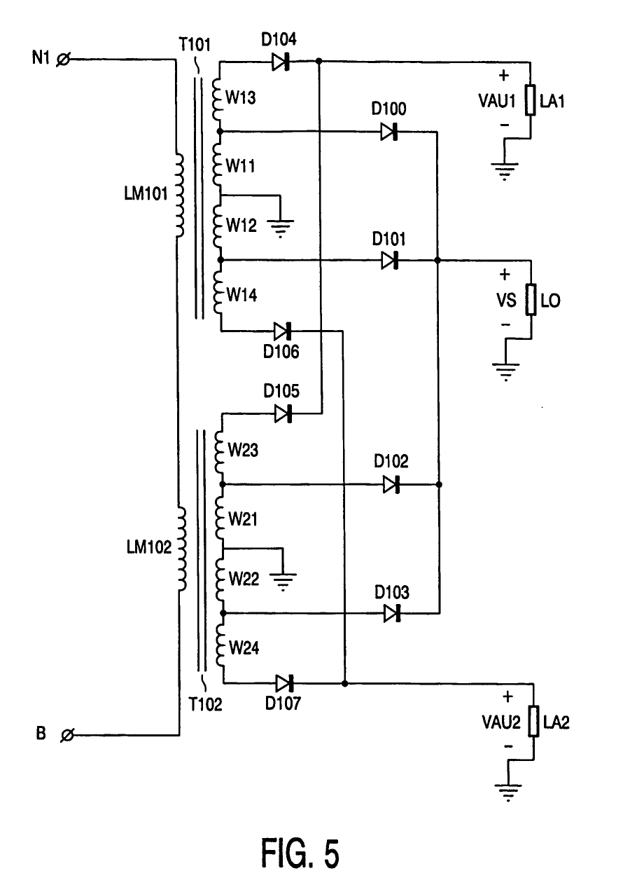

FIG. 5 shows a circuit diagram of an embodiment in accordance with the invention. The transformer T101 has a primary winding LM101, and secondary windings W11 to W14 which are arranged in series in the order W14, W12, W11, W13 from bottom to top. The junction of the windings W11 and W12 is connected to ground. The diode D100 is coupled to the junction of the windings W11 and W13 and supplies the output voltage VS (which may be a sustain voltage required in a plasma display panel) to the main load LO. The diode D101 is coupled to the junction of the windings W12 and W14 to the load LO. The still free end of winding 13 is coupled via the diode D104 to supply the auxiliary voltage VAU1 to the load LA1. The still free end of winding 14 is coupled via the diode D106 to supply the auxiliary voltage VAU2 to the load LA2.

The transformer T102 has a primary winding LM102, and secondary windings W21 to W24 which are arranged in series in the order W24, W22, W21, W23 from bottom to top. The junction of the windings W21 and W22 is connected to ground. The junction between the windings W21 and W23 is coupled via the diode D102 to the main load LO. The junction between the windings W22 and W24 is coupled via the diode D103 to the load LO. The still free end of winding 23 is coupled via the diode D105 to the load LA1. The still free end of winding 24 is coupled via the diode D107 to the load LA2. All the voltages VAU1, VAU2 and VS are defined with respect to ground.

The primary windings LM101 and LM102 are arranged in series between the nodes N1 and B.

The circuit is completely symmetric and thus the currents through corresponding diodes during the same phase are equal. For Example, during the phase that the voltages across the secondary windings are such that the diodes D104, D100, D105, D102 are conductive while the other diodes are blocking, the windings W13 and W23 are supplying the same currents, and thus also the windings W11 and W21 are supplying the same currents. During this phase, the power supplied by the winding W11 is the total power supplied by the power converter with transformer T101 minus the power supplied by the winding W13.

If the loads at both the auxiliary voltages VAU1 and VAU2 are equal, in the next period wherein all voltages across the transformer have the opposite polarity, the same currents are supplied. For example, the windings W12 and W22 supply equal currents which are the same as the currents supplied by the windings W11 and W21 during the preceding phase.

During all phases, the power supplied to the auxiliary voltages VAU1, VAU2 must be lower than the total power the power converters have to transfer to the secondary side of the transformers T101 and T102. This ensures that during each phase, both the transformers T101 and T102 supply current to the load LO.

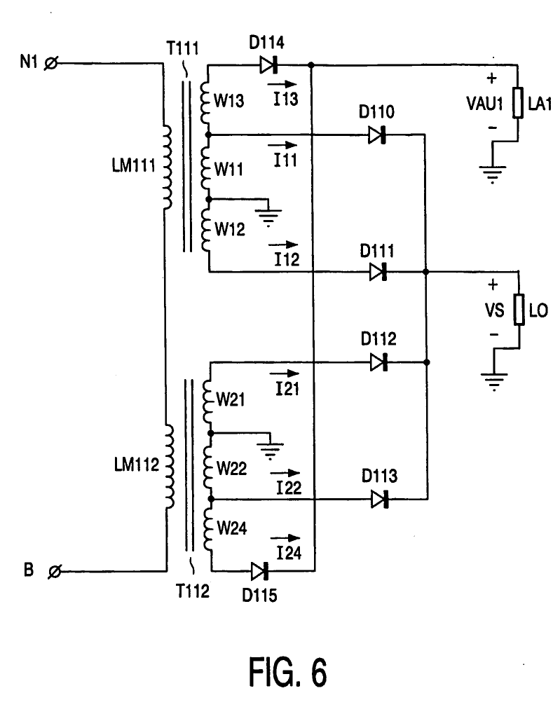

FIG. 6 shows a circuit diagram of an embodiment in accordance with the invention. The transformer T111 has a primary winding LM111, and secondary windings W11 to W13 which are arranged in series in the order W12, W11, W13. The junction of the windings W11 and W12 is connected to ground. The junction of the windings W11 and W13 is coupled via the diode D110 to supply the sustain voltage VS to the load LO. The still free end of the winding W12 is coupled to the load LO via the diode D111. The still free end of winding W13 supplies the auxiliary voltage VAU1 across the load LA1 via the diode D114.

The transformer T112 has a primary winding LM112, and secondary windings which are arranged in series in the order W24, W22, W21. The junction of the windings W21 and W22 is connected to ground. The junction of the windings W22 and W24 is coupled via the diode D113 to the load LO. The still free end of the winding W21 is coupled to the load LO via the diode D112. The still free end of winding W24 supplies the auxiliary voltage VAU1 via the diode D115.

The primary windings LM111 and LM112 are arranged in series between the nodes N1 and B.

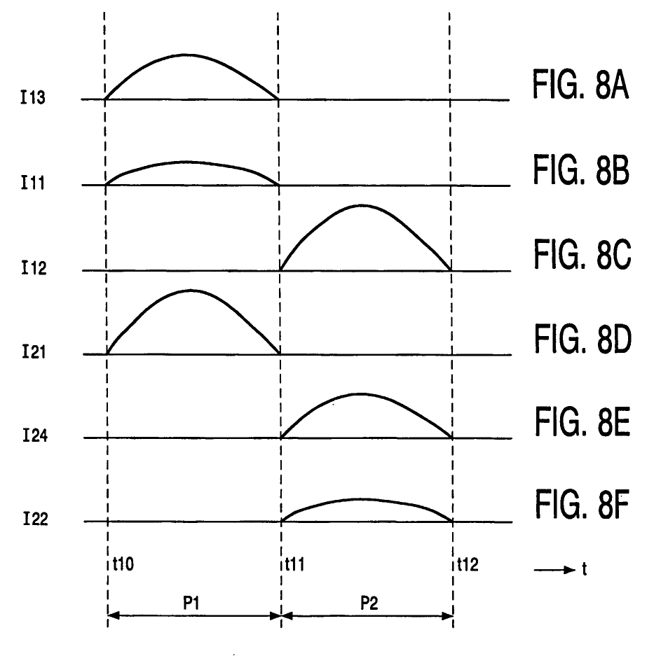

Waveforms of currents flowing in the windings W11, W12, W13, W21, W22, W24 are shown in FIGS. 8.

The number of turns of winding W13 is equal to the number of turns of winding W24.

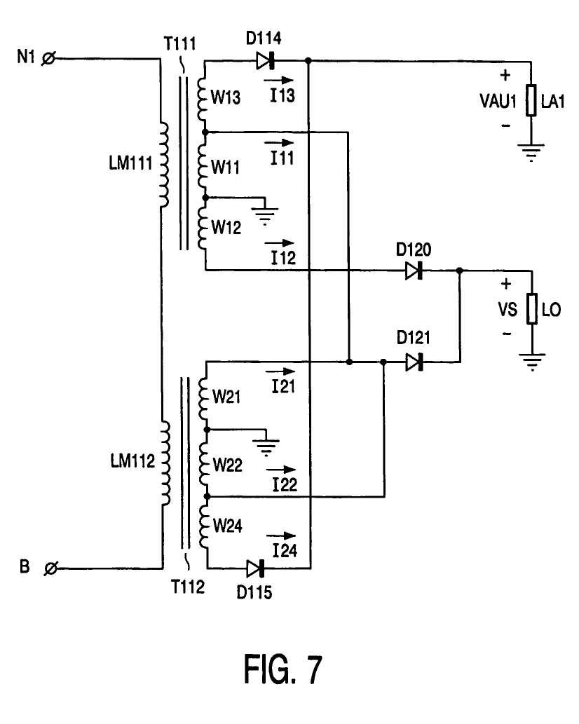

FIG. 7 shows a circuit diagram of an embodiment in accordance with the invention. FIG. 7 is based on FIG. 6, the differences are explained in the now following. Instead of providing a separate diode for each secondary winding which supplies current to the main load LO, the secondary windings W11 and W21 are arranged in parallel and supply their current to the load LO via the same diode D121. In the same manner, the secondary windings W12 and W22 are arranged in parallel and supply their current to the main load via the same diode D120. The circuit operates in the same manner as, and shows the same current waveforms as the circuit shown in FIG. 6, but advantageously requires less diodes.

FIG. 8 shows currents as a function of time to elucidate the operation of the embodiment shown in FIGS. 6 and 7.

FIG. 8A shows the current I13 in the winding W13, FIG. 8B shows the current I11 in the winding W11, FIG. 8C shows the current I12 in the winding W12, FIG. 8D shows the current I21 in the winding W21, FIG. 8E shows the current I24 in the winding W24, and FIG. 8F shows the current I22 in the winding W22.

A first phase P1 starts at the instant t10 and ends at the instant t11. A second phase P2 starts at the instant t11 and ends at the instant t12. During the phase P1, the voltages across the transformer windings W11, W12, W13, W21, W22, W24 have a polarity such that the diodes D110, D112 and D114 (in FIG. 6, or the diodes D121 and D123 in FIG. 7) are conducting while the diodes D111, D113 and D115 (in FIG. 6, or the diodes D120 and D124 in FIG. 7) are non-conductive.

FIGS. 8A and 8B show that the current I13 supplied by the auxiliary winding W13 to the auxiliary load LA1 is relatively large and thus the current I11 supplied by the same transformer T111 via the winding W11 to the main load LO, is relatively small. The main power to the main load LO is supplied by the winding W21 of the transformer T112 because the transformer T112 does not supply current to the auxiliary load LA1 during the first phase P1.

During the phase P2, the transformer T111 supplies all the power to the main load LO while the transformer T112 supplies a relatively small power to the main load LO as the majority of the power has to be supplied to the auxiliary load LA1.

This asymmetrical circuit allows supplying a large part of the output power to the auxiliary load LA1.

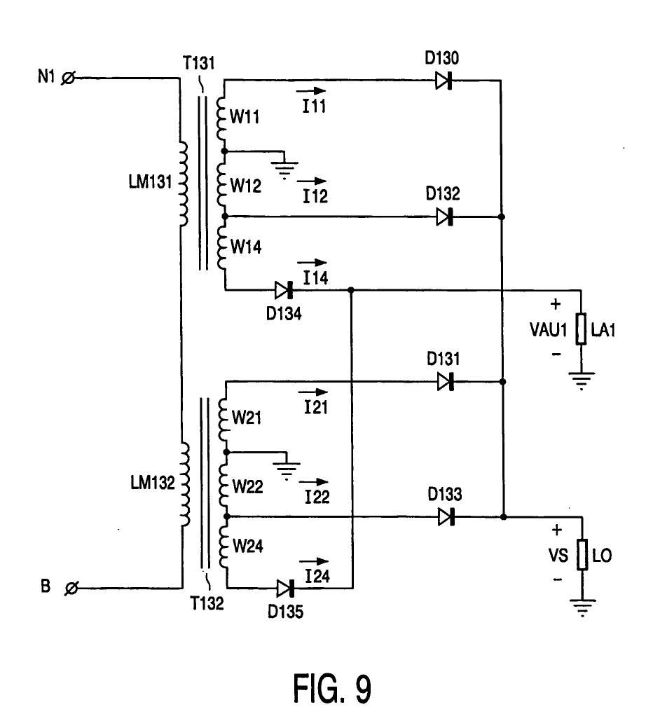

FIG. 9 shows a circuit diagram of an embodiment in accordance with the invention. The transformer T131 has a primary winding LM131, and three secondary windings which are arranged in series in the order W14, W12, W11 from bottom to top. The junction of the windings W11 and W12 is connected to ground. The junction of the windings W12 and W14 is coupled via the diode D132 to supply the voltage VS to the load LO. The still free end of the winding W11 is coupled to the load LO via the diode D130. The still free end of winding W14 supplies the auxiliary voltage VAU1 to the load LA1 via the diode D134.

The transformer T132 has a primary winding LM132, and three secondary windings which are arranged in series in the order W24, W22, W21. The junction of the windings W21 and W22 is connected to ground. The junction of the windings W22 and W24 is coupled via the diode D133 to the load LO. The still free end of the winding W21 is coupled to the load LO via the diode D131. The still free end of winding W24 supplies the auxiliary voltage VAU1 via the diode D135.

The primary windings LM131 and LM132 are arranged in series between the nodes N1 and B.

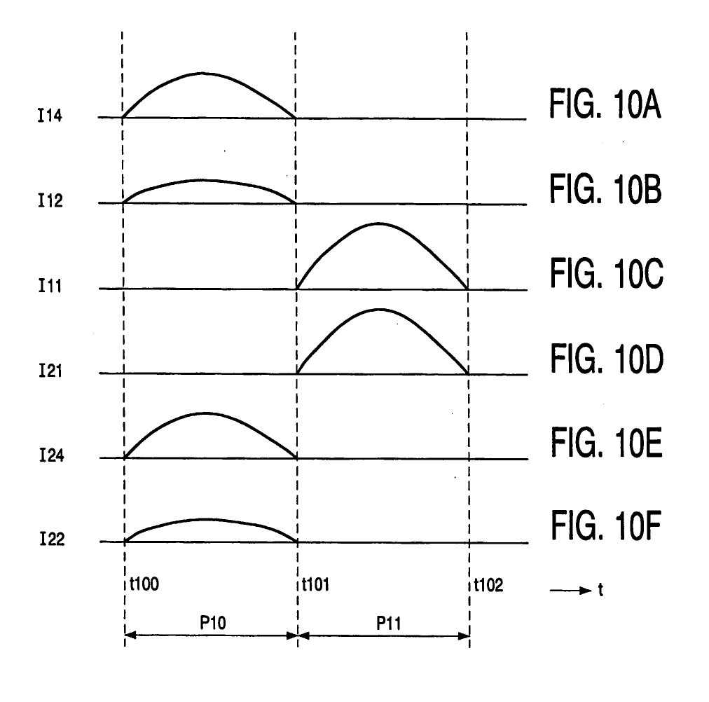

Waveforms of currents flowing in the windings W11, W12, W14, W21, W22, and W24 are shown in FIGS. 10.

FIGS. 10 show waveforms as function of time for elucidating the embodiments shown in FIG. 9.

FIG. 10A shows the current I14 in the winding W14, FIG. 10B shows the current I12 in the winding W12, FIG. 10C shows the current I11 in the winding W11, FIG. 10D shows the current I21 in the winding W21, FIG. 10E shows the current I24 in the winding W24, and FIG. 10F shows the current I22 in the winding W22.

A first phase P10 starts at the instant t100 and ends at the instant t101. A second phase P11 starts at the instant t101 and ends at the instant t102. During the phase P10, the voltages across the transformer windings W12, W14, W22, W24 have a polarity such that the diodes D132, D134, D133 and D135 in FIG. 9 are conducting while the diodes D130 and D131 in FIG. 9 are non-conductive.

FIGS. 10A, 10B, 10E and 10F show that the currents I14 and I24 supplied to the auxiliary load LA1 by the auxiliary winding W14 and W24, respectively, is relatively large and thus the currents I12 and I22 via the winding W12 and W22, respectively, to the main load LO, is relatively small. The main power to the main load LO is supplied by the windings W11 and W21 because no current is supplied to the auxiliary load LA1 during the phase P2.

FIGS. 6, 7 and 9 reveal embodiments in accordance with the invention which use a lower number of output diodes, while preserving the characteristics of equalizing voltages across the transformers and without sacrificing the prevention of a DC bias in the transformers. In each of the embodiments, any of the two transformers may provide additional auxiliary output voltages, each of which can be supplied by a center-tapped secondary winding (with two diodes) and each of which can be supplied by one winding and a rectifier bridge.

The main difference between FIG. 5 and FIGS. 6, 7 and 9 is that in FIG. 5 each of the two transformers T101 and T102 delivers output power to the auxiliary outputs in both phases of the bridge current, and in FIGS. 6, 7 and 9 each of the two transformers delivers part of the auxiliary power, thus the distribution of the auxiliary output powers can be selected such that the temperature rise can be equaled between the two transformers, allowing the absolute maximum possible level of output power that can be delivered by the combination of the transformers.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

To summarize, the invention is related to a resonant LLC-power converter which comprises at least two transformers of which the primary windings are connected in series. Each one of the transformers has a secondary winding which supplies a non-zero current to the same load during the same period of time.

1. A resonant LLC power converter comprising at least two transformers, primary windings of the at least two transformers are coupled in series, each one of the at least two transformers has a secondary winding for supplying a non-zero current to a same load during a substantially same period of time.

2. A resonant LLC power converter as claimed in claim 1, wherein the first transformer has a first predetermined number of further secondary windings for supplying a first total power to associated loads, the first total power being less then the power supplied by the second secondary winding.

3. A resonant LLC power converter as claimed in claim 2, wherein the second transformer has a second predetermined number of further secondary windings for supplying a second total power to associated loads, wherein both the first total power minus the second total power is less than the power supplied by the first secondary winding, and the second total power minus the first total power is less than the power supplied by the second secondary winding.

4. A resonant LLC power converter as claimed in claim 3, wherein at least one of the first predetermined number of further secondary windings and an associated rectifier is poled for delivering power to at least one of the associated loads, during a half wave of a resonance current in the first transformer with a first polarity, and at least one of the second predetermined number of further secondary windings and an associated rectifier is poled for supplying power to the at least one of the associated loads during a half wave of a resonant current in the second transformer with a polarity opposite to the first polarity.

5. A resonant LLC power converter as claimed in claim 1, and comprising,
a resonance capacitor,
a series arrangement of a first electronic switch and a second electronic switch for receiving a direct current input voltage,
the at least two transformers comprising a first transformer having a first primary winding and a first secondary winding being coupled via a first rectifier circuit to a load for supplying current to the load during a conductive period of the first rectifier circuit,
a second transformer having a second primary winding and a second secondary winding being coupled via a second rectifier circuit to the load for supplying current to the load during a conductive period of the second rectifier,
wherein the first primary winding, the second primary winding and the resonance capacitor are arranged in series across the second electronic switch, and
the first primary winding and the second primary winding, and the first rectifier circuit and the second rectifier circuit being poled to obtain a substantially coincidence of the conductive period of the first rectifier circuit and the conductive period of the second rectifier circuit to obtain a first voltage across the first primary winding being substantially equal to a second voltage across the second primary winding during the conductive period of the first rectifier circuit.

6. An electronic apparatus comprising a resonant LLC power converter with at least two transformers, primary windings of the at least two transformers are coupled in series, each one of the at least two transformers has a secondary winding for supplying a non-zero current to a same load during a substantially same period of time.
